(19) United States
(12) Patent Application Publication
(10) Pub. No.: US 2013/0110551 A1
(43) Pub. Date: May 2, 2013

(54) SYSTEMS AND METHODS FOR MANAGING CHRONIC CONDITIONS

(71) Applicant: WellDoc, Inc., (US)

(72) Inventor: Demir Bingol, Kennett Square, PA (US)

(73) Assignee: WELLDOC, INC.

(21) Appl. No.: 13/662,201

(22) Filed: Oct. 26, 2012

Related U.S. Application Data
(60) Provisional application No. 61/552,839, filed on Oct. 28, 2011.

(51) Int. Cl. G06Q 50/24

(52) U.S. Cl. 705/3

(57) ABSTRACT

Systems and methods of pain management comprising analysis of one or more pain metrics are disclosed. The pain metrics may include pain scores, functionality scores, and medication use. The analysis may include application of one or more algorithms to provide context and calibrate the level, degree, and/or quality of pain reported to generate a recommended action and/or course of treatment.

### CROSS-REFERENCE TO RELATED APPLICATIONS

This application claims the benefit of priority to U.S. Provisional Application No. 61/552,839, filed Oct. 28, 2011, which is incorporated by reference herein in its entirety.

### DESCRIPTION OF THE DISCLOSURE

1. Field of the Disclosure

Embodiments of the present disclosure relate generally to systems and methods for managing one or more health conditions, such as, e.g., acute or chronic conditions, and more particularly to embodiments of systems and methods for managing chronic pain.

2. Background

Pain generally refers to suffering associated with a physical ailment, bodily discomfort, or other health-related disorder, although pain may also arise from mental suffering or distress. Acute pain generally describes pain that is transitory in nature. Sources of acute pain may include, for example, temporary injury and recovery from surgery. Pain may also be associated with chronic health conditions. Chronic pain generally describes pain experienced for a longer period of time, such as months to years. A person may, for example, suffer from chronic pain for a considerable portion of his/her lifetime. Sources of chronic pain may include long-term injury, disease, and general age-related decline in health.

The subjective nature of how pain is experienced and communicated can present difficulty to healthcare providers in determining how to prescribe effective treatment for patients. Healthcare providers may also have incomplete data about a patient's condition between office visits, which can inhibit their ability to monitor and provide assistance to patients. Thus, there is a need for improving pain management by enabling healthcare providers to better understand a patient's reported pain within the context of his/her overall lifestyle and health status.

The present disclosure generally relates to systems and methods for managing a health condition, such as an acute or chronic condition, comprising analysis of a set of metrics such as, e.g., pain metrics. The analysis may contextualize a reported pain level taking into consideration other aspects of a patient's health status and lifestyle, including, e.g., functionality and medication use. The methods and systems disclosed herein may provide improved ways of capturing, understanding, minimizing, reducing, and/or otherwise managing pain and its effect on a patient.

### SUMMARY OF THE DISCLOSURE

The present disclosure is drawn to methods of managing a patient's chronic condition, such as, e.g., pain. In one embodiment, the method may include receiving patient data, wherein the patient data may include one or more pain metrics comprising at least one pain score. The method may also include accessing a database to perform an analysis of the patient data. The database may include auxiliary data relating to a pain history of the patient. Further, the method may include generating at least one recommended action based on the analysis and transmitting the at least one recommended action to at least one output device.

Embodiments of the disclosed methods may include one or more of the following features: the one or more pain metrics may include at least one functionality score and medication use; the patient data may be entered into an input device by the patient for transmission to a server; the at least one pain score may be based on an alpha-numeric scale or visual analog scale; the at least one functionality score may be based on an alpha-numeric scale or visual analog scale; the at least one functionality score may be measured on a quality of life scale; the medication use may include information about the patient's compliance with a prescribed treatment plan; the medication use may include information about the patient's use of pharmacologic agents; the analysis may include determining an aggregated score from the patient data; the auxiliary data may include a predetermined treatment plan; the auxiliary data may include one or more pain metrics for the patient reported at an earlier time; the one or more pain metrics reported at an earlier time may include at least one pain score, at least one functionality score, and medication use; the analysis may include a statistical analysis; the analysis may include a pattern recognition analysis; the at least one recommended action may include instructing the patient to consult a healthcare provider; the at least one recommended action may include instructing the patient to comply with a prescribed treatment plan; and the at least one recommended action may be transmitted to at least two output devices, wherein a first output device displays the at least one recommended action to the patient and a second output device displays the at least one recommended action to a healthcare provider.

The present disclosure further includes a method of managing pain of a patient including entering patient data into an input device, wherein the patient data comprises one or more pain metrics comprising at least one pain score; transmitting the patient data to a server; accessing a database to perform an analysis of the patient data, the database comprising auxiliary data relating to a pain history of the patient; generating at least one recommended action based on the analysis; and transmitting the at least one recommended action to at least one output device.

Embodiments of the method may include one or more of the following features; the one or more pain metrics may include at least one functionality score and medication use; the medication use may include information about the patient's compliance with a prescribed treatment plan; the medication use may include information about the patient's use of pharmacologic agents; the analysis may include determining an aggregated score from the patient data; the auxiliary data may include a predetermined treatment plan; the auxiliary data may include one or more pain metrics for the patient reported at an earlier time; the one or more pain metrics reported at an earlier time may include at least one pain score, at least one functionality score, and medication use; the analysis may include a statistical analysis; the analysis may include a pattern recognition analysis; the at least one recommended action include instructing the patient to consult a healthcare provider; the at least one recommended action may include instructing the patient to comply with a prescribed treatment plan; and the at least one recommended action may be transmitted to at least two output devices, wherein a first output device displays the at least one recommended action to the patient and a second output device displays the at least one recommended action to a healthcare provider.

The present disclosure further includes a system including an input device for receiving patient data comprising one or more pain metrics via a user interface, the one or more pain metrics including at least one pain score, at least one functionality score, and medication use; a transmitter for transmitting the patient data over a wireless channel; a server for receiving the transmitted patient data; a database for analyzing the patient data and generating at least one recommended action; and at least one output device for displaying the at least one recommended action,

Embodiments of the system may include one or more of the following features: the input device may include the at least one output device; the database may include data for the patient that was previously entered and transferred to the database; and the patient data previously entered and transferred may comprise an aggregated score.

### BRIEF DESCRIPTION OF THE FIGURES

FIG. 1 shows a flow chart depicting exemplary steps of a method, according to the present disclosure.

FIG. 2 schematically illustrates a system, according to the present disclosure.

FIG. 3 shows a data display as described in Example 1.

### DETAILED DESCRIPTION OF EMBODIMENTS

The systems and methods disclosed herein may analyze a set of pain metrics in order to help a healthcare provider understand, diagnose, treat, minimize, reduce, and/or manage a patient's pain, regardless of etiology (e.g., nociceptive, neuropathic, musculoskeletal, osteoarthritic, migraine, etc.). The analysis may include application of one or more algorithms to provide context for and calibrate the level, degree, and/or quality of pain reported by a patient. In some embodiments, the algorithm(s) may generate a recommended action and/or course of treatment. The present disclosure may provide real-time and trended views of patient data, providing healthcare providers with more complete data upon which to base pain treatment/management recommendations.

The systems and methods presently disclosed may utilize objective and subjective data to generate an individualized patient assessment to enable healthcare providers to make better, more personalized treatment decisions in a timely manner. As used herein, the term “healthcare provider” includes licensed and unlicensed professionals who assist in human health management, including, but not limited to, physicians, physicians assistants, nurses, clinicians, medical specialists, physical therapists, and others who provide preventative, curative, therapeutic, and/or rehabilitative treatments and services. The term “patient” as used herein is understood to include any person regardless of whether he/she is under the care of a healthcare provider. In some embodiments of the present disclosure, the pain management systems and methods provide for operation between a patient and healthcare provider. In other embodiments, a patient may seek and/or receive pain management guidance without consulting a healthcare provider.

Those of ordinary skill in the art will recognize that the embodiments described herein may be used in conjunction with any health condition, including one or more chronic conditions. Thus, it should be noted that the discussion of pain management is exemplary and only for discussion purposes.

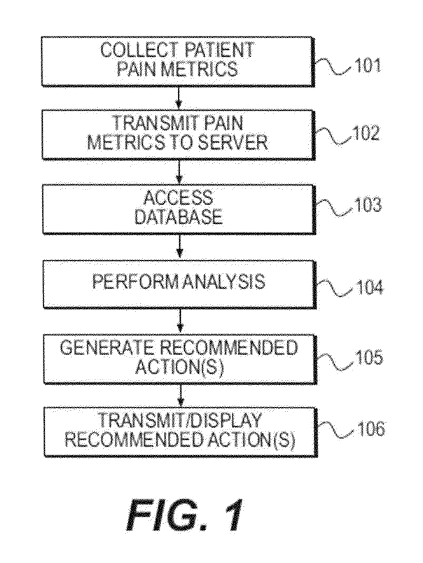

FIG. 1 illustrates exemplary steps of a method according to the present disclosure. Patient metrics are collected (step 101), transmitted, and received by a suitable server (step 102). The server may communicate with a database (step 103) and analysis of the pain metrics is performed (step 104). One or more recommended actions is generated (step 105), and transmitted and displayed (step 106) on an output device. Variations of, and alternatives to, the foregoing steps are further contemplated and consistent within the methods disclosed herein. Multiple servers and/or databases may be used, such as connected through a network. The server(s) and/or database(s) may, e.g., be connected locally or remotely. In some embodiments, for example, the database may be saved on a local computer or server. In other embodiments, the database may be stored remotely including, for example, via cloud computing.

Pain Metrics

Pain metrics suitable for the present disclosure include pain scores, functionality scores, and medication use. Each of these metrics is discussed in greater detail below. Further contemplated as pain metrics are biometric data that provide an indication of the amount of pain a patient experiences. Such biometric data may include, but is not limited to, brain imaging. Pain scores, functionality scores, and medication use may be self-reported by a patient. A patient may also provide pain metrics to a healthcare provider for analysis.

Pain Score

As alluded to above, pain metrics may be one type of metrics utilized within the principles of the present disclosure. A pain score can be based on any type of alpha-numeric or visual analog scale. Non-limiting examples include the 100 millimeter pain scale and the Wong Baker FACES pain scale. Pain scales may or may not be clinically validated and may use any scale (e.g. 1-100, 1-10, 1-4), picture, symbol, color, character, number, sound, letter, or written description of pain to facilitate the communication of a patient's pain level. The type of pain scale used may be determined according to a patient's and/or healthcare provider's preferences, and may also be determined based on the needs of a patient including, for example, the patient's age and/or communication capability. In further embodiments, the selected pain scale(s) may be determined by a service provider, such as, e.g., an organization implementing the principles of the present disclosure via a suitable software program or application.

Functionality Score

Another metric may include a functionality score. A functionality score can be based on any type of alpha-numeric or visual analog scale. Non-limiting examples include the American Chronic Pain Association Quality of Life (ACPA QoL) Scale, Global Assessment of Functioning (GAF) Scale, and Short Form SF-36 Health Survey. Functionality scales may or may not be clinically validated and may use any picture, symbol, color, character, number, sound, letter, written description of quality of life, or physical functioning to facilitate communication of a patient's functionality level. The functionality score may be, e.g., based on an assessment of a patient's ability to exercise as well as perform daily tasks and/or perform routine tasks such as, e.g., getting dressed, grocery shopping, cooking, cleaning, climbing stairs, etc. In some embodiments, the selected functionality scale(s) may be determined by a service provider, such as, e.g., an organization implementing the principles of the present disclosure via a suitable software program or application.

Medication Use

A further metric may include a patient's medication usage. Medication use encompasses pharmacologic and therapeutic agents used to treat, control, and/or alleviate pain regardless of etiology (e.g., nociceptive, neuropathic, musculoskeletal, osteoarthritic, migraine, etc.), including prescription drugs as well as over-the-counter medications, therapeutic agents, and other non-prescription agents. Medication use may include different classes of pharmacologic agents including, but not limited to, analgesics such as opioid analgesics non-steroidal anti-inflammatory drugs (NSAIDs), triptans, anti-epileptics, anti-depressants, anesthetics (including, e.g., local and topical), anti-convulsants, muscle relaxants, and sedatives. Non-limiting examples include acetaminophen, oxymorphone, fluoxetine, warfarin, and senna. The methods and systems presently disclosed also may provide information regarding drug/drug interactions. In some embodiments, for example, medications targeted for treatment(s) other than related to pain may be reported and analyzed for potential interactions with pain medications.

Medication use can be reported in any appropriate units, such as number of doses taken, percentage of treatment plan completed, frequency of doses, and/or dose strength; and may also specify additional information such as the type of formulation taken and the route of administration (oral, enteral, topical, transdermal, parenteral, sublingual etc.). Molecular alternatives (e.g., acid, salt, solvate, complex, and pro-drug forms, etc.) and formulations (e.g., solid, liquid, powder, gel, and suspensions, etc.) are further contemplated. Reported medication use may, for example, include the number of doses and types of medication taken since a previous reported medication use, and may also indicate the number of closes and types of medication taken within a period of time, such as within, the previous 2 hours, 4 hours, 6 hours, 12 hours, 18 hours, 24 hours, 36 hours, or 48 hours. In some embodiments, for example, medication use may be reported in terms of dosage units recommended by a manufacturer or healthcare provider for a given medication (e.g., minimum, maximum, or range of appropriate unit dosage per unit time).

Reported medication use may allow for tracking compliance with a treatment regime. For example, a record of reported medication use may assist a healthcare provider in evaluating medication efficacy, adjusting dosage, and/or adding other medications as necessary (e.g., prescribing an immediate or “rescue” medication to alleviate episodic or break-through pain).

In some embodiments of the present disclosure, a patient or healthcare provider may create a patient profile comprising, e.g., identifying, characterizing, and/or medical information, including information about a patient's medical history, profession, and/or lifestyle. Further examples of information that may be stored in a patient profile includes diagnostic information such as family medical history, medical symptoms, duration of pain, localized vs. general pain, etc. Further contemplated as part of a patient profile are non-pharmacologic treatment(s) (e.g., chiropractic, radiation, holistic, psychological, acupuncture, etc.), lifestyle characteristics (e.g., diet, alcohol intake, smoking habits), cognitive condition, behavioral health, and social well-being.

A patient profile may, for example, be stored in a database and accessible for analysis of the patient's reported pain metrics. In some embodiments, a patient profile may be created before collecting and/or transmitting a set of pain metrics to be received by a server and/or database In other embodiments, a patient profile may be created concurrently with, or even after transmitting/receiving one or more pain metrics. In some embodiments a patient profile may be used to establish one or more pain metric e and/or reference values. A patient profile may, for example, allow for setting threshold values or ranges, wherein reported pain metrics that fall outside of those limits trigger an alert to be sent to the patient or a healthcare provider. Threshold values, limits, or ranges may also be set without reference to a patient profile. In some embodiments, one or more target value(s) (e.g., pain metric value(s)) may be set to determine how the reported pain metrics compare with the target value(s).

Algorithm

The methods and systems disclosed herein may rely on one or more algorithm(s) to analyze one or more of the described metrics. The algorithm(s) may comprise analysis of data reported in real-time, and may also analyze data reported in real-time in conjunction with auxiliary data stored in a pain management database. Such auxiliary data may comprise, for example, historical patient data such as previously-reported pain metrics (e.g., pain scares, functionality scores, medication use), personal medical history, and/or family medical history. In some embodiments, for example, the auxiliary data includes at least one set of pain metrics previously reported and stored for a patient. In some embodiments, the auxiliary data includes a patient profile such as, e.g., the patient profile described above. Auxiliary data may also include statistical data, such as pain metrics pooled for a plurality of patients within a similar group or subgroup. Further, auxiliary data may include clinical guidelines such as guidelines relating to pain management, including evidence-based clinical practice guidelines on the management of acute and/or chronic pain or other chronic conditions.

Analysis of a set of pain metrics according to the present disclosure may allow for calibration of the level, degree, and/or quality of pain experienced by providing greater context to patient-reported data. For example, associating a pain score of 7 out of 10 with high functionality for a first patient, and the same score with low functionality for a second patient may indicate a relatively greater debilitating effect of pain on the second patient than the first patient. Further, a high pain score reported by a patient taking a particular medication such as opioid analgesics may indicate a need to adjust the patient's treatment plan. Further, the methods and systems disclosed herein may provide a means of assessing relative changes in a patient's distress due to pain over time. For example, a pain score of 5 out of 10 for a patient who previously reported consistently lower pain scores, e.g., 1 out of 10, may indicate a serious issue requiring immediate medical attention.

Any combination(s) of pain metrics may be used for analysis in the systems and methods disclosed. In some embodiments, for example, the set of pain metrics comprises at least one pain score and at least one functionality score. In other embodiments, the set of pain metrics may comprise at least one pain score, at least one functionality score, and medication use. More than one set of pain metrics may be reported and analyzed at a given time. For example, a first set of pain metrics recording a patient's current status and a second set of pain metrics recording the patient's status at an earlier time may both be analyzed and may also be used to generate one or more recommended actions.

Each pain metric may be given equal weight in the analysis, or may also be given greater or less weight than other pain metrics included in the analysis. For example, a functionality score may be given greater or less weight with respect to a pain score and/or medication use. Whether and/or how to weigh a given pain metric may be determined according to the characteristics or needs of a particular patient. As an example, Patient A reports a pain score of 8 (on a scale of 1 to 10 where 10 is the most severe pain) and a functionality score of 9 (on a scale of 1 to 10 where 10 is highest functioning), while Patient B reports a pain score of 8 but a functionality score of 4. The present disclosure provides for the collection, analysis, and reporting of this information, taking into account the differential impact of one pain score on a patient's functionality versus that same pain score's impact on the functionality of a different patient.

Pain metrics may undergo a pre-analysis before inclusion in a set of pain metrics and subsequent application of one or more algorithms. For example, a raw score may be converted or scaled according to one or more algorithm(s) developed for a particular patient. In some embodiments, for example, a non-numerical raw score may be converted to a numerical score or otherwise quantified prior to the application of one or more algorithms. Patients and healthcare providers may retain access to raw data (e.g., pain metric data prior to any analysis)

Algorithm(s) according, to the present disclosure may analyze the set of pain metrics according to any suitable methods known in the art. Analysis may comprise, for example, calculation of statistical averages, pattern recognition, application of mathematical models, factor analysis, correlation, and/or regression analysis. Examples of analyses that may be used herein include, but are trot limited to, those disclosed in U.S. Patent Application Publication No. 2012/0246102 A1 the entirety of which is incorporated herein by reference.

The present disclosure further provides for the determination of an aggregated pain assessment score. In some embodiments, for example, a set of pairs metrics may be analyzed to generate a comprehensive and/or individualized assessment of pain by generating a composite or aggregated score. In such embodiments, the aggregated score may include a combination of at least one pain score, at least one functionality score, and medication use. Additional metrics may also be included in the aggregated score. Such metrics may include, but are not limited to, exercise habits, mental well-being, depression, cognitive functioning, medication side effects, etc. Any of the aforementioned types of analyses may be used in determining an aggregated score.

The algorithm(s) may include a software program that may be available for download to an input device in various versions. In some embodiments, for example, the algorithm(s) may be directly downloaded through the Internet or other suitable communications means to provide the capability to troubleshoot a health issue in real-time. The algorithm(s) may also be periodically updated, e.g., provided content changes, and may also be made available for download to an input device.

The methods presently disclosed may provide a healthcare provider with a more complete record of a patient's day-to-day status. By having access to a consistent data stream of pain metrics for a patient, a healthcare provider may he able to provide the patient with timely advice and real-time coaching on pain management options and solutions. A patient may, for example, seek and/or receive feedback on pain management without waiting for an upcoming appointment with a healthcare provider or scheduling a new appointment. Such real-time communication capability may be especially beneficial to provide patients with guidance and treatment options during intervals between appointments with a healthcare provider. Healthcare providers may also be able to monitor a patient's status between appointments to timely initiate, modify, or terminate a treatment plan as necessary. For example, a patient's reported medication use may convey whether the patient is taking too little or too much medication. In some embodiments, an alert may be triggered to notify the patient and/or a healthcare provider of the amount of medication taken, e.g., in comparison to a prescribed treatment plan. The healthcare provider could, for example, contact the patient to discuss the treatment plan. The methods disclosed herein may also provide a healthcare provider with a longitudinal review of how a patient responds to pain over time. For example, a healthcare provider may be able to determine whether a given treatment plan adequately addresses a patient's needs based on review of the patient's reported pain metrics and analysis thereof according to the present disclosure.

Analysis of patient data according to the methods presently disclosed may Generate one or more recommended actions that may be transmitted and displayed on an output device. In some embodiments, the analysis recommends that a patient make no changes to his/her treatment plan or routine. In other embodiments, the analysis generates a recommendation that the patient seek further consultation with a healthcare provider and/or establish compliance with a prescribed treatment plan. In other embodiments, the analysis may encourage a patient to seek immediate medical attention. For example, the analysis may generate an alert to be transmitted to one or more output devices, e.g., a first output device belonging to the patient and a second output device belonging to a healthcare provider, indicating that the patient is in need of immediate medical treatment. In some embodiments, the analysis may not generate a recommended action. Other recommended actions consistent with the present disclosure may be contemplated and suitable according to the treatment plans, needs, and/or preferences for a given patient.

The present disclosure further provides a means for monitoring a patient's medication use to determine when his/her prescription will run out and require a refill. For example, a patient profile may be created that indicates a prescribed dosage and frequency of administration, as well as total number of dosages provided in a single prescription. As the patient reports medication use, those pain metrics may be transmitted to a server and stored in a database in connection with the patient profile. The patient profile stored on the database may thus continually update with each added metric and generate a notification to indicate when the prescription will run out based on the reported medication use. The notification may be transmitted and displayed on one or more output devices, e.g., to a patient and/or one or more healthcare providers. In some embodiments, the one or more healthcare providers may include a pharmacist. For example, a pharmacist may receive notification of the anticipated date a prescription will run out in order to ensure that the prescription may be timely refilled.

System

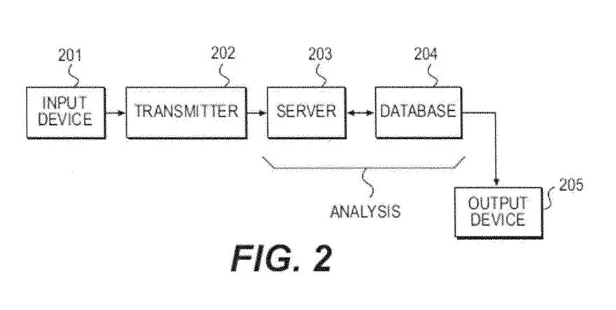

FIG. 2 shows a schematic of a system according to the present disclosure. A system may, for example, comprise an input device 201 for receiving patient data, a transmitter 202 for transmitting the data over a wired or wireless medium, a server 203 for receiving the transmitted data, a database 204 for analyzing the data and generating one or more recommended actions, and at least one output device 205 for displaying the recommended action(s).

Patient data can be input for analysis according to the systems disclosed herein through any data-enabled device including, but not limited to, portable/mobile and stationary communication devices, and portable/mobile and stationary computing devices. Non-limiting examples of input devices suitable for the systems disclosed herein include smart phones, cell phones, laptop computers, netbooks, personal computers (PCs), tablet PCs, fax machines, personal digital assistants, and/or personal medical devices. The user interface of the input device may be web-based, such as a web page, or may also be a stand-alone application. Input devices may provide access to software applications via mobile and wireless platforms, and may also include web-based applications.

The input device may receive data by having a user, including, but not limited to, a patient, family member, friend, guardian, representative, healthcare provider, and/or caregiver, enter particular information via a user interface, such as by typing and/or speaking. In some embodiments, a server may send a request for particular information to be entered by the user via an input device. For example, an input device may prompt a user to enter sequentially a set of pain metrics, e.g., a pain score, a functionality score, and information regarding use of one or more medications (e.g., type of medication, dosage taken, time of day, route of administration, etc.). In other embodiments, the user may enter data into the input device without first receiving a prompt. For example, the user may initiate an application or web-based software program and select an option to enter one or more pain metrics. In some embodiments, one or more pain scales and/or functionality scales may be preselected by the application or software program. For example, a user may have the option of selecting the type of pain scale and/or functionality scale for reporting pain metrics within the application or software program. In other embodiments, an application or software program may not include preselected pain scales or functionality scales such that a user can employ any pain scale and/or functionality scale of choice.

The user interface of an input device may allow a user to associate pain metrics with a particular date and/or time of day. For example, a user may report one or more pain metrics to reflect a patient's present status. A user may also report one or more pain metrics to reflect a patient's status at an earlier time.

Patient data may be electronically transmitted from an input device over a wired or wireless medium to a server, e.g., a remote server. The server may provide access to a database for performing an analysis of the data transmitted, e.g., set of pain metrics. The database may comprise auxiliary data for use in the analysis as described above. In some embodiments, the analysis may be automated, and may also be capable of providing real-time feedback to patients and/or healthcare providers.

The analysis may generate one or more recommended actions, and may transmit the recommended action(s) over at wired or wireless medium for display on at least one output device. The at least one output device may include, e.g., portable/mobile and stationary communication devices, and portable/mobile and stationary computing devices. Non-limiting examples of output devices suitable for the systems disclosed herein include smart phones, cell phones, laptop computers, netbooks, personal computers (PCs), tablet PCs, fax machines, personal digital assistants, and/or personal medical devices. In some embodiments, the input device is the at least one output device. In other embodiments, the input device is one of multiple output devices. In some embodiments of the present disclosure, the one or more recommended actions are transmitted and displayed on each of two output devices. In such an example, one output device may belong to a patient and the other device may belong to a healthcare provider.

The present disclosure also contemplates methods and systems in a language suitable for communicating with the patient and/or healthcare provider, including languages other than English.

A patient's medical data may be subject to confidentiality regulations and protection. Transmitting, analyzing, and/or storing information according to the methods and systems disclosed herein may be accomplished through secure means, including HIPPA-compliant procedures and use of password-protected devices, servers, and databases.

The systems and methods presently disclosed may be especially beneficial in outpatient, home, and/or on-the-go settings. The systems and methods disclosed herein may also be used as an inpatient tool and/or in controlled medication administration such as developing a personalized treatment plan.

### EXAMPLES

The following examples are intended to illustrate the present disclosure without being limiting in nature. It is understood that the skilled artisan will envision additional embodiments consistent with the disclosure provided herein.

### Example

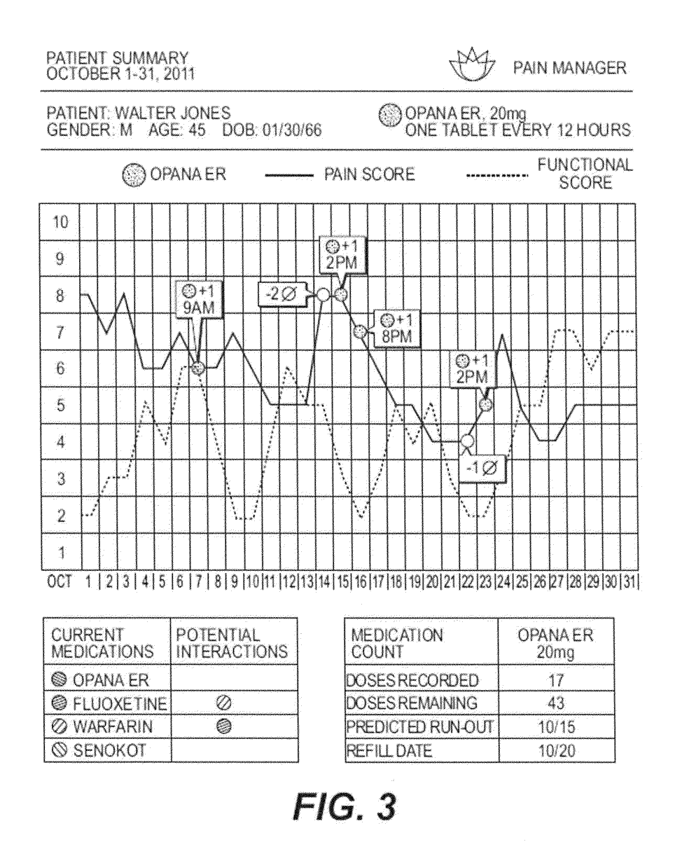

This example relates to a 45 year-old male patient suffering from chronic pain. His doctor may prescribe a treatment regime comprising oral administration of Opana® ER at a dose of one 20 mg tablet every 12 hours. Between doctor's visits, the patient inputs a pain score, a functionality score, and his medication use into a pain management application installed on his mobile phone. The patient also records use of other medications, including fluoxetine, warfarin, and Senokot®, See FIG. 3. The pain management application displays dosage information for pain medication, including the number of doses of Opana® ER taken, the number of doses remaining, the predicted date that the patient's supply will run out, and the prescription refill date. Based on the prescribed treatment regime, the patient's doctor advises him to input a pain score, a functionality score, and a report of his medication use at least twice per day. The doctor monitors information reported by the patient via a web-based version of the pain management application, which allows the doctor to observe associations between the patient's pain scores, functionality scores and medication taking behavior.

The pain management application includes various settings, including an option for an alert to be sent to the patient and/or his doctor when the patient has missed one or more doses or taking more doses than prescribed and other options for an alert when the patient's pain score or functionality score falls outside of a pre-determined range of values. As shown in FIG. 3, the patient reports pain and functionality scores regularly (e.g., once or more per day), but reports medication use less consistently (e.g., every several days). Upon noting the patient's irregular medication usage, the doctor may contact the patient to inquire about compliance with the prescribed treatment regime and his pain and functionality status.

Embodiments of the present disclosure may be used in the treatment and/or management of any patient ailment, including, but not limited to chronic conditions such as, e.g., pain. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and exampled be considered as exemplary only, with a true scope and spirit of the disclosure being indicated by the following claims.

What is claimed is:

1. A method of managing pain of a patient comprising:
receiving patient data, wherein the patient data comprises one or more pain metrics, and wherein the one or more pain metrics includes at least one pain score;
accessing a database to perform an analysis of the patient data, the database comprising auxiliary data relating to a pain history of the patient;
generating at least one recommended action based on the analysis; and
transmitting the at least one recommended action to at least one output device.

2. The method of claim 1, wherein the one or more pain metrics further comprises at least one functionality score and medication use.

3. The method of claim 1, wherein the patient data is entered into an input device by the patient for transmission to a server.

4. The method of claim 1, wherein the at least one pain score is based on an alpha-numeric scale or visual analog scale.

5. The method of claim 2, wherein the at least one functionality score is based on an alpha-numeric scale or visual analog scale.

6. The method of claim 5, wherein the at least one functionality score is measured on a quality of life scale.

7. The method of claim 2, wherein the medication use comprises information about the patient's compliance with a prescribed treatment plan.

8. The method of claim 2, wherein the medication use comprises information about the patient's use of pharmacologic agents.

9. The method of claim 1, wherein the analysis comprises determining an aggregated score from the patient data.

10. The method of claim 1, wherein the auxiliary data comprises a predetermined treatment plan.

11. The method of claim 1, wherein the auxiliary data comprises one or more pain metrics for the patient reported at an earlier time.

12. The method of claim 11, wherein the one or more pain metrics reported at an earlier time comprises at least one pain score, at least one functionality score, and medication use.

13. The method of claim 1, wherein the analysis comprises a statistical analysis.

14. The method of claim 13, wherein the analysis comprises a pattern recognition analysis.

15. The method of claim 1, wherein the at least one recommended action comprises instructing the patient to consult a healthcare provider.

16. The method of claim 7, wherein the at least one recommended action comprises instructing the patient to comply with the prescribed treatment plan.

17. The method of claim 1, wherein the at least one recommended action is transmitted to at least two output devices, wherein a first output device displays the at least one recommended action to the patient and a second output device displays the at least one recommended action to a healthcare provider.

18. A method of managing pain of a patient comprising:
entering patient data into an input device, wherein the patient data comprises one or more pain metrics comprising at least one pain score;
transmitting the patient data to a server;
accessing a database to perform an analysis of the patient data, the database comprising auxiliary data relating to a pain history of the patient;
generating at least one recommended action based on the analysis, and
transmitting the at least one recommended action to at least one output device.

19. The method of claim 18, wherein the one or more pain metrics further comprises at least one functionality score and medication use.

20. The method of claim 19, wherein the medication use comprises information about the patient's compliance with a prescribed treatment plan.

21. The method of claim 19, wherein the medication use comprises information about the patient's use of pharmacologic agents.

22. The method of claim 18, wherein the analysis comprises determining an aggregated score from the patient data.

23. The method of claim 18, wherein the auxiliary data comprises a predetermined treatment plan.

24. The method of claim 18, wherein the auxiliary data comprises one or more pain metrics for the patient reported at an earlier time.

25. The method of claim 24, wherein the one or more pain metrics reported at an earlier time includes at least one pain score, at least one functionality score, and medication use.

26. The method of claim 18, wherein the analysis comprises a statistical analysis.

27. The method of claim 26, wherein the analysis comprises a pattern recognition analysis.

28. The method of claim 18, wherein the at least one recommended action includes instructing the patient to consult a healthcare provider.

29. The method of claim 20, wherein the at least one recommended action includes instructing the patient to comply with the prescribed treatment plan.

30. The method of claim 18, wherein the at least one recommended action is transmitted to at least two output devices, wherein a first output device displays the at least one recommended action to the patient and a second output device displays the at least one recommended action to a healthcare provider.

31. A pain management system comprising:
an input device for receiving patient data comprising one or more pain metrics via a user interface, the one or more pain metrics comprising at least one pain score, at least one functionality score, and medication use;
a transmitter for transmitting the patient data over a wireless channel;
a server for receiving the transmitted patient data;
a database for analyzing the patient data and generating at least one recommended action; and
at least one output device for displaying the at least one recommended action.

32. The system of claim 31, wherein the input device is the at least one output device.

33. The system of claim 31, wherein the database comprises data for the patient that was previously entered and transferred to the database.

34. The system of claim 33, wherein the patient data previously entered and transferred comprises an aggregated score.
